(19) United States
(12) Patent Application Publication
(10) Pub. No.: US 2011/0232154 A1
(43) Pub. Date: Sep. 29, 2011

(54) Animated decoy system

(76) Inventor: Virgil Nolan Crank, JR., Sedgewickeville, MO (US)

(21) Appl. No.: 13/065,574

(22) Filed: Mar. 24, 2011

Related U.S. Application Data
(60) Provisional application No. 61/317,779, filed on Mar. 26, 2010.

(51) Int. Cl. A01M 31/06

(52) U.S. Cl. 43/3

(57) ABSTRACT

A radio controlled animated decoy system is disclosed that provides two or more animated decoys that are operable using a wireless radio controller where each of the two animated decoys is equipped with a multichannel radio receiver that can receive the signals from the wireless controller thereby allowing each of the animated decoys to operate on one of the multichannel frequencies available such that the motion of each decoy can be controlled independently of the other decoy o result in a more realistic action for the decoys.

### CROSS REFERENCE TO RELATED APPLICATIONS

This application claims the benefit of U.S. Provisional Application No. 61/317,779 filed on Mar. 26, 2010. The entire disclosure of that provisional application is hereby incorporated by reference into the disclosure of this document is if fully stated herein.

### STATEMENT REGARDING FEDERALLY SPONSORED RESEARCH

Not Applicable.

### FIELD OF THE INVENTION

This disclosure relates to the field of animated decoys used in the sport of wildlife hunting.

### BACKGROUND OF THE INVENTION

This section provides general background information related to the present disclosure and the background information is not necessarily prior art.

There are a wide variety of decoys that are used in various types of hunting. More particularly, decoys are almost always used when game birds are being hunted. In that situation, it is important that the decoy being used to entice a gamer bird into the hunter's field of vision be a decoy that offers appearances and actions that are most likely to simulate the game bird being hunted.

Proper animation of decoys has been found to be particularly effective in drawings game birds close to the hunter. Stationary and non-moving decoys may provide an initial enticement to a game bird to enter a hunting area, however, when a game bird does not see the decoy move, the game bird may realize that there is something unusual about the decoy and decide not to enter the hunting area.

Therefore there is a need for an animated decoy that can work in conjunction with at least one other animated decoy such that each animated decoy can independently simulate more realistic game bird movements to attract game birds to a hunting area.

### SUMMARY OF THE INVENTION

This section provides a general summary of the disclosure, and is not a comprehensive disclosure of its full scope or all of its features.

In accordance with the various embodiments of the present invention, this invention relates to a system of animated radio controlled decoys simulating two or more feeding birds moving independently as controlled by the user.

Further areas of applicability will become apparent from the description provided herein. The description and specific examples in this summary are intended for purposes of illustration only and are not intended to limit the scope or the claims of the present disclosure.

### DESCRIPTION OF THE DRAWINGS

In the accompanying drawings which form part of this specification:

FIG. 1 shows a partially exploded view of one embodiment of the present invention;

FIG. 2 shows a perspective view of one embodiment of the present invention;

FIG. 3 shows an exploded view of the upper portion of one embodiment of the present invention; and

FIG. 4 shows an operational schematic one embodiment of the present invention.

Corresponding reference numerals indicate corresponding steps or parts throughout the several figures of the drawings.

While one embodiment of the present invention is illustrated in the above referenced drawings and in the following description, it is understood that the embodiment shown is merely one example of a single preferred embodiment offered for the purpose of illustration only and that various changes in construction may be resorted to in the course of manufacture in order that the present invention may be utilized to the best advantage according to circumstances which may arise, without in any way departing from the spirit and intention of the present invention, which is to be limited only in accordance with the claims contained herein.

### DETAILED DESCRIPTION OF A PREFERRED EMBODIMENT OF THE INVENTION

In the following description, numerous specific details are set forth such as examples of some preferred embodiments, specific components, devices, methods, in order to provide a thorough understanding of embodiments of the present disclosure. It will be apparent to a person of ordinary skill in the art that these specific details need not be employed, and should not be construed to limit the scope of the disclosure. In the development of any actual implementation, numerous implementation-specific decisions must be made to achieve the developer's specific goals, such as compliance with system-related and business-related constraints. Such a development effort might be complex and time consuming, but is nevertheless a routine undertaking of design, fabrication, and manufacture for those of ordinary skill.

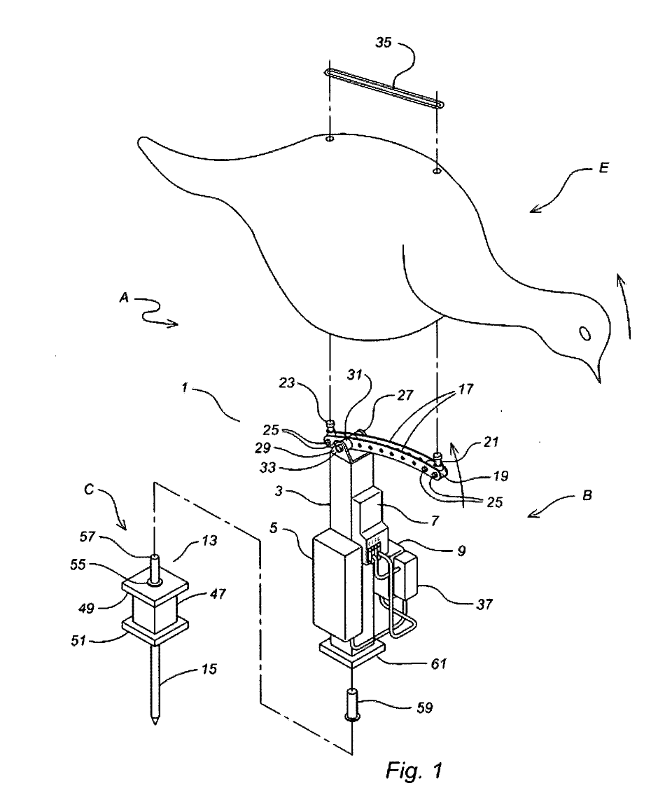

A preferred embodiment of the present invention is illustrated in the drawings and figures contained within this specification. More specifically, certain preferred embodiments of the present invention are generally disclosed and described in FIGS. 1-4.

Referring now to FIG. 1, an animated decoy system A is shown. The animated decoy system A comprises an upper portion B, and a lower portion C. The upper portion B includes a vertical actuator assembly 1, an upper support 3, a battery pack 5, a wireless receiver 7, and a servo motor 9. The lower portion C includes a stake 15.

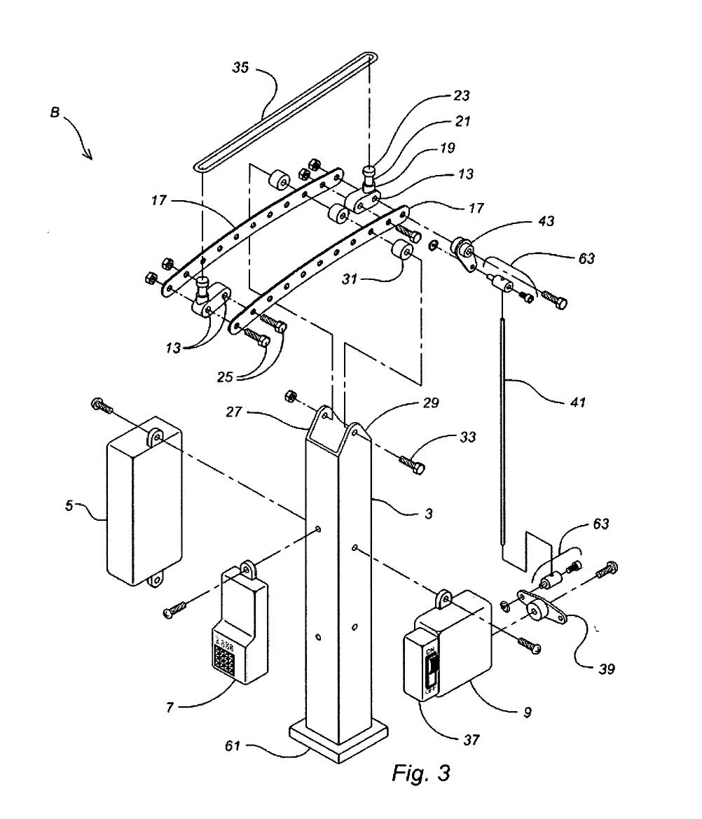

The vertical actuator assembly 1 comprises two support plates 17 (FIG. 3) that are assembled together with two spacers 19 that are disposed between each of the two support plates. The two spacers 19 are generally L-shaped with two openings 13 disposed on the horizontal leg of the L-shape and an upper protrusion 21 on the vertical leg of the L shape. It is understood that the upper protrusion 21 on each spacer 19 has a pin 23.

When the vertical actuator assembly 1 is assembled, one of the upper supports 3 is positioned on each side of the two spacers 19 with one of the spacers 19 located near the ends of each of the two upper supports such that the upper protrusions 21 is disposed on the upper side of the vertical actuator assembly. At each end of the vertical actuator assembly 1, two fasteners 25 are installed through the upper support 3, through the spacer 19, and then through the other upper support. It is understood that the fasteners are installed through the two openings 13 located in the horizontal leg of the L shape of the spacers 19. It will be appreciated by those of skill in the art that the placement of two fasteners 25 through the two openings 13 of the horizontal leg of the L shape of the spacers 19 acts to prevent the spacers from rotating between the two upper supports 3 when a horizontal force is applied to the two pins 23. In this manner, the upper protrusion 21 remains pointed upward in relation to the vertical actuator assembly 1.

The upper support 3 of the present embodiment is made from a square tube. An arcuate portion 27 is located at an upper end of the upper support. It is understood that the opposing sides of the square shape of the upper support 3 have the same general arcuate portion at the same end of the upper support. Each of the opposing sides of the square tube also has a through opening 29 located on the longitudinal axis of the upper support 3 and near the upper edge of the arcuate portion 27. The through openings 29 are in axial alignment.

The vertical actuator assembly 1 is movably attached to the upper support 3 by placing the vertical actuator assembly between the two sides of the square shape of the upper support at the arcuate portion 27 of the upper support. Three pivot spacers 31 are positioned between each side of the vertical actuator assembly 1 and the two sides of the upper support 2 having the arcuate portion 27, and then a set of pivoting fasteners 33 are installed through the upper support, the pivoting spacers, and the vertical actuator assembly. It is understood that when the vertical actuator assembly 1 is installed onto the upper support 3 such that the vertical actuator assembly is free to pivot about the pivot fasteners 33. During installation of a decoy body E, an elastic element 35 is stretched to spread between, and be installed upon, each of the two pins 23 of the upper protrusions 21 of the two spacers 19. The purpose of the elastic element 35 is to hold the decoy body E onto the vertical actuator assembly 1 and will be further explained below.

The battery pack 5 is mounted to the upper support 3 at a position on the upper support 3 that will not interfere with the movement of the vertical actuator assembly 1 on the upper support. In the present embodiment, the battery pack 5 includes two AA batteries to provide power to the wireless receiver 7 and the servo motor 9. In alternative embodiments, the battery pack 5 may include other types and voltage of batteries. In yet other embodiments, the electrical power supplied to the wireless receiver 7 and the servo motor 9 can be supplied through a portable power source that is operatively connected to those components with various types of electrical cables and connectors that are well known in the art. A switch 37 is also mounted onto the upper support 3 and, when fully wired, controls the power to be supplied to the wireless receiver 7 and the servo motor 9.

The wireless receiver 7 is also mounted to the upper support 3 and is located near the battery pack 5 and at a position on the upper support that does not interfere with the movement of the vertical actuator assembly 1. In the present embodiment, the wireless receiver 7 is a two channel 2.4 GHZ radio control transmitter. In one preferred embodiment, the wireless receiver is a Model TR324 3-channel 2.4 GHz receiver made by Tactic and is used with a Model TTX240 2.4 GHz ground radio system also made by Tactic.

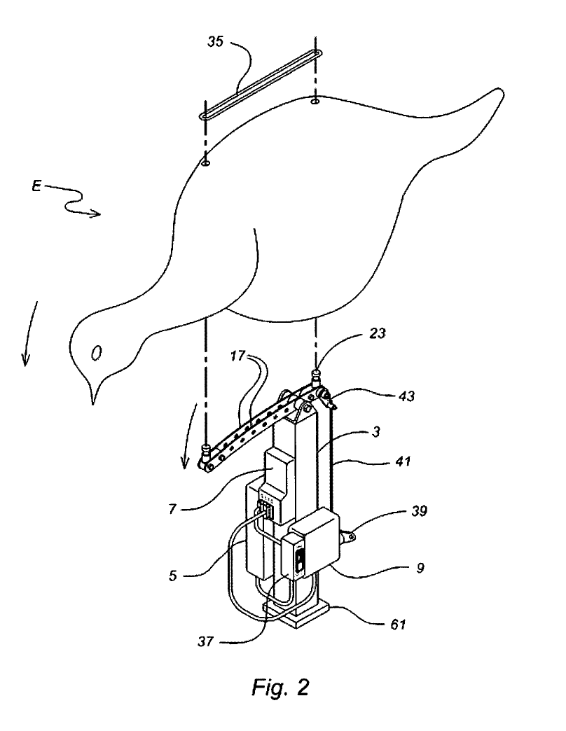

The servo motor 9 of the present embodiment has a reaction speed of about 0.2 seconds and a torque of about 7.7 kg-cm. The servo motor 9 is mounted to the upper support 3 such that the rotational axis of the drive crank 39 on the output of the servo motor is generally parallel with the longitudinal axis of the vertical actuator assembly 1. In the present embodiment, the servo 9 is a Model HCAM0191 CS-70MG Super-Torque MG 2BB made by Hobbico. The drive crank 39 of the servo motor 9 is operatively connected to the vertical actuator assembly 1 by a linkage 41 connected to the drive crank 39 and a drive connector 43 that is attached to one end of the vertical actuator assembly 1. The operating distance between the drive connector 43 and the drive crank 39 is adjusted by clamping elements 63 at the ends of the linkage 41. It is understood that after the servo motor 9 is operatively connected to the vertical actuator assembly 1 by the linkage 41, that operation of the wireless controller D will cause the servo motor 9 to rotate through a certain arc segment as shown by the arrow in FIG. 1 and FIG. 2 to push or pull the linkage 41 thus causing the vertical actuator assembly 1 to generate an up and down motion depending upon the signal received from the wireless controller D. In the present embodiment, the linkage 41 is made from stainless steel, however, other types of corrosion resistant metals may also be used and remain within the scope of the present invention. While corrosion resistant metals are preferred, it is understood that any type of material may be used to make the linkage 41 as long as the material selected provides the structural integrity to needed to sufficiently transfer the forces from the servo motor 9 to the vertical actuator assembly 1.

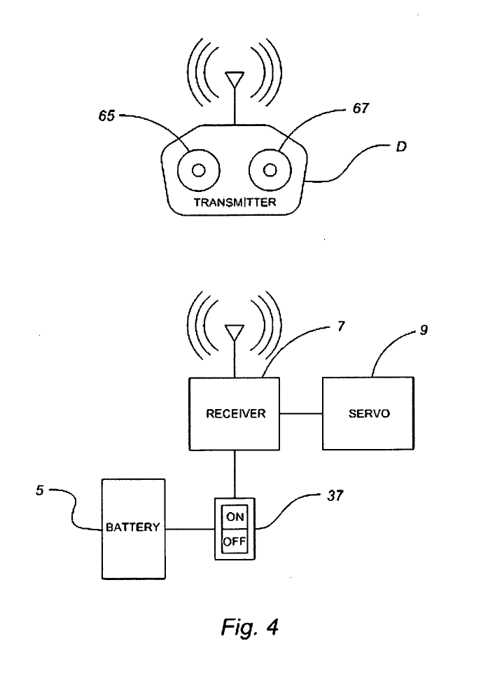

Because the wireless receiver 7 has more than one channel, it is understood that the connection of the wireless receiver to the servo motor 9 determines which wireless channel is used to operate a specific animated decoy system. For example, in the present embodiment, the wireless receiver 7 has at least two separate channels. Thus, one animated decoy system A would be assembled to connect the servo motor 9 to a first channel of the wireless receiver 7. A second animated decoy system A would be assembled to connect the servo motor 9 to a second channel of the wireless receiver 7. When two animated decoy systems A are assembled in this manner, each of the animated decoy systems can be independently controlled by the wireless controller D having two channels of operation. This is to say, a first control lever 65 (FIG. 4) of the wireless controller D can send a signal on the first channel to animate the first animated decoy system A while a second control lever 67 can send an independent signal on the second channel to animate the second animated decoy system A. This ability to separately control each of the animated decoy systems A results in a much more realistic animation by the decoys and will result in higher likelihood that a game bird will be deceived into believe the animated decoy systems are real birds.

It is understood that while the current embodiment comprises a wireless receiver 7 (FIG. 4) a wireless controller having D two channels, that the number of channels can be any number.

The lower portion C (FIG. 1) comprises a lower support 47 in the present embodiment, the lower support 47 is made from a square tube about 1.5 inches long with an upper cap 49 and lower cap 51 located at the top and bottom of the lower support respectively. The upper cap 49 has an opening into which a first top-hat bushing 55 is disposed. A pivot rod 57 is slideably disposed within the first top-hat bushing 55. The stake 15 protrudes from the lower cap 51. A second top-hat bushing 59 is inserted into a second bottom cap 61 located in a second opening of the upper portion B and the top portion of the pivot rod 57 is slideably disposed into the second top-hat bushing 59. It will be appreciated by those skilled in the art that the slideable placement of the pivot rod 57 into the first top-hat bushing 55 and the second top-hat bushing 59 allows the upper portion B to rotate freely in relation to the bottom portion C.

A decoy body E is placed upon the upper portion B by inserting the upper body into the hollow cavity of the decoy body. The insertion is complete when the two pins 23 pass through two mounting openings 69 in the decoy body E and the two pins are exposed on the outside surface of the decoy body. The elastic element 35 is then installed onto the two pins 23 to captivate a portion of the decoy body E between the elastic portion and the vertical actuator assembly 1. It is understood that while the decoy body E shown in the present embodiment simulates a turkey, decoy bodies that simulate any other type of bird may also be used and remain within the intended scope of the present invention.

The set up of the animated decoy system A includes first identifying an area generally known to be visited by the game bird that a hunter wishes to obtain. The lower portion C is then installed into the ground at the selected area by inserting the stake 15 into the ground. The upper portion B is then placed upon the lower portion C by inserting the pivot rod 57 in the first top-hat bushing 55 and the second top-hat bushing 59, and then placing the upper portion B onto the pivot rod. This allows the upper portion B to swivel freely on the lower portion C to result in what is known as a “wind vane” motion. The decoy body E is placed onto the upper portion B by inserting the two pins 23 through the two small openings in the decoy body, and the elastic element 35 is stretched over and installed onto the two pins to hold the decoy body onto the vertical actuator assembly 1. The switch 37 is then placed in the “ON” position. The animated decoy system A is now ready for operation.

Operation of the animated decoy system A includes the controlled movement of the vertical actuator assembly 1 by manipulation of the wireless controller D. More specifically, the wireless controller D of the present exemplary embodiment has at least two channels of operation and two animated decoy systems A are installed used. When the user wishes the first animated decoy system to animate, the user operates a lever on the wireless controller D to move the head portion of the decoy body E down in a pecking or eating simulation. The user at a later time re-manipulates the lever of the wireless controller D to move the head portion of the decoy body E upward to end the pecking or eating simulation. At an independently timed moment, e second lever of the wireless controller D can be operated to cause a second animated decoy system A to move the head portion of the decoy body E down in an pecking or eating simulation. Then, as before, the user at a later time re-manipulates the lever of the wireless controller D to move the head portion of the decoy body E upward to end the pecking or eating simulation. Using a wireless controller/wireless receiver system having more than one channel allows the user to have more than two animated decoy systems A—all of which can be independently controlled to simulate the normal action of a game bird. The end result is a set of animated decoys that appear more realistic and thus more convincing to game birds to entice the game birds into the range of the hunter.

In the preceding description, numerous specific details are set forth such as examples of specific components, devices, methods, in order to provide a thorough understanding of embodiments of the present disclosure. It will be apparent to a person of ordinary skill in the art that these specific details need not be employed, and should not be construed to limit the scope of the disclosure. In the development of any actual implementation, numerous implementation-specific decisions must be made to achieve the developer's specific goals, such as compliance with system-related and business-related constraints. Such a development effort might be complex and time consuming, but is nevertheless a routine undertaking of design, fabrication and manufacture for those of ordinary skill. The scope of the invention should be determined by any appended claims and their legal equivalents, rather than by the examples given.

Additionally, it will be seen in the above disclosure that several of the intended purposes of the invention are achieved, and other advantageous and useful results are attained. As various changes could be made in the above constructions without departing from the scope of the invention, it is intended that all matter contained in the above descriptions or shown in the accompanying drawings shall be interpreted as illustrative and not in a limiting sense.

Terms such as “proximate,” “distal,” “upper,” “lower,” “inner,” “outer,” “inwardly,” “outwardly,” “exterior,” “interior,” and the like when used herein refer to positions of the respective elements as they are shown in the accompanying drawings, and the disclosure is not necessarily limited to such positions. Terms such as “first,” “second,” and other numerical terms when used herein do not imply a sequence or order unless clearly indicated by the context.

When introducing elements or features and the exemplary embodiments, the articles “a,” “an,” “the” and “said” are intended to mean that there are one or more of such elements or features. The terms “comprising,” “including,” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It will also be understood that when an element is referred to as being “operatively connected,” “connected,” “coupled,” “engaged,” or “engageable” to and/or with another element, it can be directly connected, coupled, engaged, engageable to and/or with the other element or intervening elements may be present. In contrast, when an element is referred to as being “directly connected,” “directly coupled,” “directly engaged,” or “directly engageable” to another element, there are no intervening elements present. Other words used to describe the relationship between elements should be interpreted in a like fashion (e.g., “between” versus “directly between,” “adjacent” versus “directly adjacent,” etc.).

What is claimed is:

1. An animated decoy system comprising:
one of either a first animated decoy or a first set of animated decoys wherein each of either the first animated decoy or the first set of animated decoys is responsive to a first unique wireless signal;
one of either a second animated decoy or a second set of animated decoys wherein each of either the second animated decoy or the second set of animated decoys is responsive to a second unique wireless signal; and
a wireless controller capable of communicating the first unique wireless signal and the second wireless signal.

2. The animated decoy system of claim 1 wherein the wireless controller communication of the first unique wireless signal is independent from the communication of the second unique wireless signal.

3. The animated decoy system of claim 2 further wherein each of the animated decoys comprises an upper portion having a wireless receiver responsive to at least one of either the first unique wireless signal or the second unique wireless signal.

4. The animated decoy system of claim 3 wherein the upper portion further comprises a vertical actuator assembly, an upper support, a battery pack, a wireless receiver, and a servo motor.

5. The animated decoy system of claim 4 wherein the vertical actuator assembly comprises two support plates that are assembled together with two spacers disposed between each of the two support plates and wherein the two spacers are generally L-shaped with two openings disposed on the horizontal leg of the L-shape and an upper protrusion in the general form of a retention pin on the vertical leg of the L shape.

6. The animated decoy system of claim 5 wherein the vertical actuator assembly includes two upper supports positioned on each side of the two spacers with one of the spacers located near each end of each of the two upper supports such that the retention pin is disposed on the upper side of the vertical actuator assembly.

7. The animated decoy system of claim 6 wherein the upper support is generally square having an arcuate portion located at an upper end of the upper support and having a through opening perpendicular to the longitudinal axis of the upper support and near the upper edge of the arcuate portion 27

8. The animated decoy system of claim 7 wherein the vertical actuator assembly is movably attached to the upper support such that the vertical actuator assembly is pivotable around a pivot installed near the arcuate section of the upper support.

9. The animated decoy system of claim 8 wherein the wireless receiver is a multi channel 2.4 GHZ radio control transmitter.

10. The animated decoy system of claim 9 wherein the servo motor has a reaction speed of about 0.2 seconds and a torque of about 7.7 kg-cm.

11. The animated decoy system of claim 10 wherein the servo motor is mounted to the upper support such that the rotational axis of a drive crank mounted on the servo motor is generally parallel with the longitudinal axis of the vertical actuator assembly.

12. The animated decoy system of claim 11 wherein the drive crank of the servo motor is operatively connected to the vertical actuator assembly by a linkage connected to the drive crank and to a drive connector attached to one end of the vertical actuator assembly such that operation of the servo motor will cause a servo motor shaft to rotate through a certain arc segment to one of either push or pull the linkage causing the vertical actuator assembly to generate one of either an up or a down motion.

13. The animated decoy system of claim 12 further comprising a lower portion having a lower support with an upper cap on a proximate end of the lower support and a lower cap on the distal end of the lower support, wherein the upper cap has an opening into which a first top-hat bushing is disposed.

14. The animated decoy system of claim 13 further comprising a pivot rod that is slideably disposed within the first top-hat bushing of the lower support and a second top-hat bushing that is in a second bottom cap located in a second opening of the upper portion to thereby allow the upper portion to rotate freely in relation to the bottom portion.

15. The animated decoy system of claim 14 further comprising a decoy body placed upon the upper portion that is held in place on the upper portion by an elastic element installed onto the two pins that have been passed trough two mounting openings in the decoy body.

16. The animated decoy system of claim 15 further comprising a stake protruding from a surface of the lower cap on the lower support.

17. The animated decoy system of claim 16 wherein manipulation of a control device of the wireless controller results in the transmission of one of either the first unique wireless signal or the second unique wireless signal.
